(19) United States
(12) Patent Application Publication
(10) Pub. No.: US 2015/0319092 A1
(43) Pub. Date: Nov. 5, 2015

(54) CONTENT AWARE WI-FI QoS

(71) Applicant: Benu Networks, Inc., Billerica, MA (US)

(72) Inventor: Rajat GHAI, Sandwich, MA (US)

(21) Appl. No.: 14/703,516

(22) Filed: May 4, 2015

Related U.S. Application Data
(60) Provisional application No. 61/987,599, filed on May 2, 2014.

(51) Int. Cl. H04L 12/801; H04L 12/66; H04L 12/851

(52) U.S. Cl. CPC H04L 47/12; H04L 47/24; H04L 12/66; H04W 84/12

(57) ABSTRACT

Described herein are techniques for providing content aware quality of service (QoS) metadata for a Wi-Fi connection to nodes in a network by incorporating the QoS metadata into a packet header so that the nodes in the network can access the QoS metadata. The Wi-Fi access gateway receives a data packet for an internet protocol (IP) connection with a radio node across the network, wherein the radio node is configured to connect to one or more Wi-Fi devices located near the radio node The Wi-Fi access gateway classifies underlying data content of the IP connection to determine QoS metadata for the IP connection based on the underlying data content. The Wi-Fi access gateway incorporates the QoS metadata into a packet header of the data packet so that nodes in the network can access the QoS metadata for the IP connection.

### RELATED APPLICATIONS

This application relates to and claims priority under 35 U.S.C. §119(e) to U.S. Provisional Patent Application No. 61/987,599, titled “Content Aware Wi-Fi QoS,” which was filed on May 2, 2014 and is hereby incorporated by reference herein in its entirety.

### FIELD

The subject matter disclosed in this application generally relates to providing content aware quality of service (QoS), and more specifically, to incorporating QoS metadata into a data packet.

### BACKGROUND

Quality of service (QoS) refers to the feature of handling data packets differently based on the content of the data packets. QoS is an important policy in allocating network traffic resources. Without QoS, each data packet can be treated equally and on a first-come, first-served basis. Treating each data packet equally is oftentimes not an ideal or efficient method of allocating network resources. As an example, a huge size system download packet may occupy a significant amount of network resource and interfere other latency-sensitive applications, such as voice over internet protocol (VoIP). As another example, treating each data packet equally cannot prioritize the senders and/or the receivers who paid more for their usage of the network.

Traditionally, QoS can be implemented by a home gateway such as a wireless router. There are, however, several problems related to this traditional approach. First, due to its size and cost, a home gateway is generally limited in computational power. Therefore, a regular home gateway may not be able to provide high granularity QoS. Specifically, typical wireless routers cannot provide application aware QoS because they lack ability to detect application type of underlying data content. Second, having each home gateway offering its own QoS may not provide users within a Wi-Fi community with universal and/or globally optimized user experience.

Therefore, there is a need in the art to provide systems and methods for improving content aware QoS. Accordingly, it is desirable to provide methods and systems that overcome these and other deficiencies of the related art.

### SUMMARY

In accordance with the disclosed subject matter, systems, methods, and computer readable media are provided for improving content aware quality of service.

Disclosed subject matter includes, in one aspect, a computerized method for providing content aware quality of service (QoS) metadata for a Wi-Fi connection to nodes in a network by incorporating the QoS metadata into a packet header so that the nodes in the network can access the QoS metadata. The method includes receiving a data packet for an internet protocol (IP) connection with a radio node across the network, wherein the radio node is configured to connect to one or more Wi-Fi devices located near the radio node. The method includes classifying underlying data content of the IP connection to determine QoS metadata for the IP connection based on the underlying data content. The method includes incorporating the QoS metadata into a packet header of the data packet so that nodes in the network can access the QoS metadata for the IP connection.

Disclosed subject matter includes, in another aspect, a computing system configured to provide content aware quality of service (QoS) metadata for a Wi-Fi connection to nodes in a network by incorporating the QoS metadata into a packet header so that the nodes in the network can access the QoS metadata. The computing system comprises a Wi-Fi access gateway that includes a processor configured to run a module stored in memory that is configured to cause the processor to receive a data packet for an internet protocol (IP) connection with a radio node across the network, wherein the radio node is configured to connect to one or more Wi-Fi devices located near the radio node. The module is configured to cause the processor to classify underlying data content of the IP connection to determine QoS metadata for the IP connection based on the underlying data content. The module is configured to cause the processor to incorporate the QoS metadata into a packet header of the data packet so that nodes in the network can access the QoS metadata for the IP connection.

Disclosed subject matter includes, in yet another aspect, a non-transitory computer readable medium comprising executable instructions operable to cause an apparatus to receive a data packet for an internet protocol (IP) connection with a radio node across the network, wherein the radio node is configured to connect to one or more Wi-Fi devices located near the radio node. The instructions are operable to cause an apparatus to classify underlying data content of the IP connection to determine QoS metadata for the IP connection based on the underlying data content. The instructions are operable to cause an apparatus to incorporate the QoS metadata into a packet header of the data packet so that nodes in the network can access the QoS metadata for the IP connection.

Before explaining example embodiments consistent with the present disclosure in detail, it is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

These and other capabilities of embodiments of the disclosed subject matter will be more fully understood after a review of the following figures, detailed description, and claims.

It is to be understood that both the foregoing general description and the following detailed description are explanatory only and are not restrictive of the claimed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings.

FIG. 1 illustrates a block diagram of a system for providing content aware quality of service (QoS) metadata, according to some embodiments of the disclosed subject matter.

FIG. 2 illustrates a block diagram of a Wi-Fi access gateway, according to some embodiments of the disclosed subject matter.

FIG. 3 illustrates a flow diagram illustrating a computerized method of providing content aware QoS metadata, according to some embodiments of the disclosed subject matter.

FIG. 4 illustrates an exemplar data packet, according to some embodiments of the disclosed subject matter.

FIG. 5 illustrates an exemplar GRE header, according to some embodiments of the disclosed subject matter.

FIG. 6 illustrates an exemplar data packet, according to some embodiments of the disclosed subject matter.

FIG. 7 illustrates an exemplar GRE header, according to some embodiments of the disclosed subject matter.

### DETAILED DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

The disclosed techniques allow for providing content aware QoS metadata for a Wi-Fi connection to nodes in a network by incorporating the QoS metadata into a packet header so that the nodes in the network can access the QoS metadata. In some embodiments, QoS metadata is provided, completely or additionally, by a Wi-Fi access gateway rather than solely by each individual home gateway. There are several advantages associated with this approach. First, a Wi-Fi access gateway generally has more computational power than a home gateway, and can therefore provide high quality QoS. Second, having a centralized QoS can ensure the users within a Wi-Fi community relatively uniformed user experience. Third, having a centralized QoS can optimize and/or prioritize network resources among different home gateways and the Wi-Fi devices associated with each home gateway.

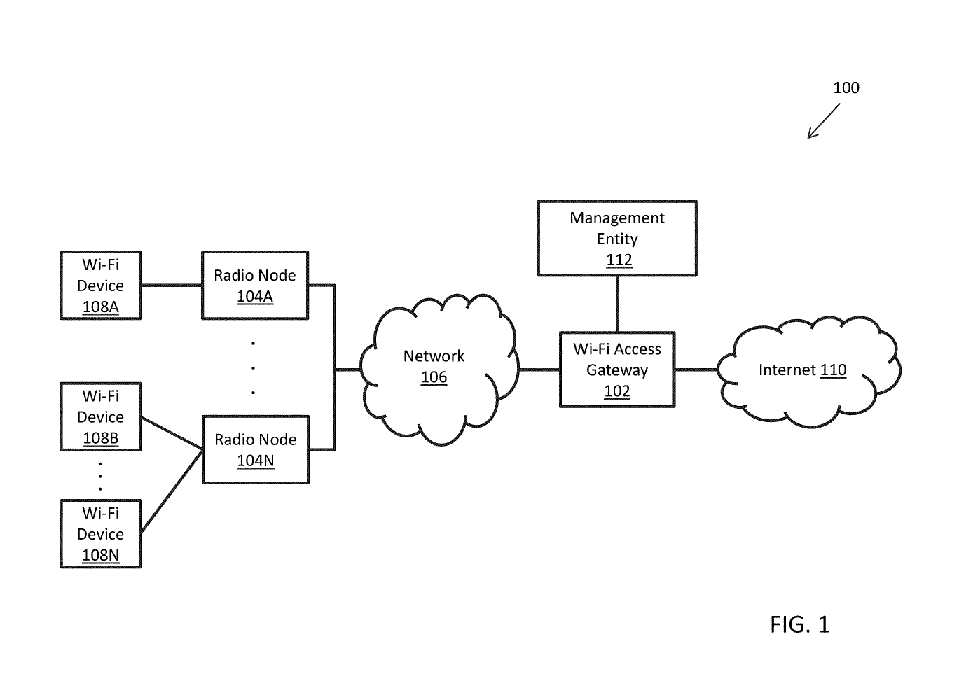

FIG. 1 illustrates a block diagram of a system 100 for providing content aware quality of service (QoS) metadata for a Wi-Fi connection to nodes in a network by incorporating the QoS metadata into a packet header so that the nodes in the network can access the QoS metadata. In some embodiments the system 100 can be a large scale Wi-Fi domain that extends to millions of Wi-Fi devices. As shown in FIG. 1, the system 100 includes a Wi-Fi access gateway 102 (also referred to herein as WAG 102) in communication with radio nodes 104A through 104N (collectively referred to herein as radio node 104) via a network 106. Each radio node 104 can be in communication with a set of Wi-Fi devices 108 (also referred to herein as user devices 108). As shown in system 100, radio node 104A is in communication with Wi-Fi device 108A and radio node 104N is in communication with Wi-Fi device 108B through Wi-Fi device 108N (collectively referred to herein as Wi-Fi device 108). The WAG 102 is connected to the Internet 110. Management entity 112 is connected to the WAG 102. The components illustrated in FIG. 1 can be further broken down into more than one component and/or combined together in any suitable arrangement. Further, one or more components can be rearranged, changed, added, and/or removed.

Referring to the WAG 102, the WAG 102 directs upstream network traffic from the Wi-Fi device 108 to the Internet 110 (e.g., and/or other downstream devices, such as routers, servers, databases, computers, and/or the like) and downstream network traffic from the Internet 110 to the Wi-Fi device 108. In some embodiments, the WAG 102 communicates with the Wi-Fi device 108 directly. In some embodiments, the WAG 102 communicates with the Wi-Fi device 108 indirectly via the radio node 104 and/or the network 106. The WAG 102 provides content aware QoS metadata to the radio node 104 by incorporating the QoS metadata into a packet header so that the radio node 114 in the network can access the QoS metadata.

The WAG 102 can provide IP services and/or muting functions, such as Dynamic Host Configuration Protocol (DHCP), Universal Plug and Play (UPnP), Network Address Translation-Port Mapping Protocol (NAT-PMP), Access Control List (ACL), the address resolution protocol (ARP), and/or other services and functions. The WAG 102 can provide dual stack Internet Protocol (IP) to offer service to both Internet Protocol version 4 (IPv4) and Internet Protocol version 6 (IPv6). As shown in FIG. 1, the WAG 102 can provide backbone connectivity to the Internet 110. The WAG 102 can also provide security and session isolation among connections with each of the radio nodes 104.

The WAG 102 can provide a data plane with radio nodes 104, such as described in U.S. patent application Ser. No. 14/460,657, titled “Systems and Methods for Sharing Digital Content in Fragments,” which is filed on Aug. 15, 2014 and is hereby incorporated by reference herein in its entirety. In some embodiments, the WAG 102 is a highly scalable platform that implements data/traffic plane aggregation of switched Ethernet virtual domains over a wide geographical area, allowing the WAG 102 to serve millions of devices. The WAG 102 can include connections to each of the radio nodes 104, such as a generic routing encapsulation (GRE) tunnel that encapsulates network traffic from the Wi-Fi devices 108, served by a corresponding radio node 104.

In some embodiments, the WAG 102 provides high performance point-to-point switched Layer 2 domain. In a classical Open Systems Interconnection (OSI) layered computer networking model, network mobility (e.g., for session persistence) is often quicker at lower layers, e.g. Ethernet (layer 2) as opposed to networking layer (L3) or application layer (L7). However, the lower layers are often more messaging intensive than higher layers. The network can be configured to provide for a wide area Layer 2 network, such that high-performance equipment is able to participate with exponentially large number of transactions per second (TPS) while still providing seamless mobility at the MAC layer (Ethernet Layer). For example, flat Layer 2 domains (e.g., also called broadcast domains) are usually geographically small by design. To create a wide area Layer 2 network, virtual networks can be created by creating Layer 2 tunnels such that two devices think that they can see each other directly, yet they are located remotely from each other. These tunnels (e.g., also called overlays) are point to point over a routed IP network. Under some embodiments, such tunnels are also called pseudo-wires.

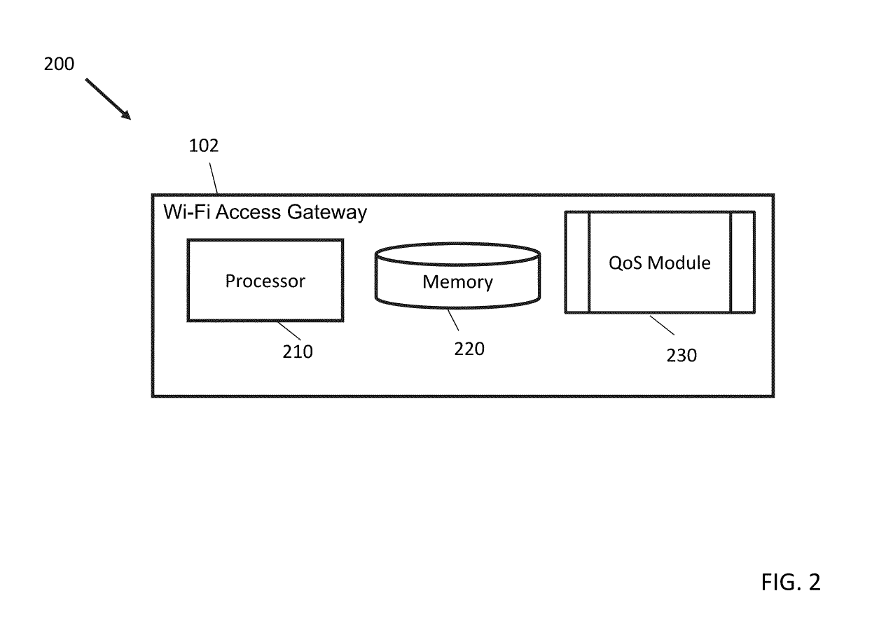

In some embodiments, the WAG 102 provides a high performance IP data/forwarding plane that can analyze, shape, forward, etc. IP traffic from end Wi-Fi devices. As alluded to above, network such as Layer 2 domains are often very messaging intensive, which is why they are often limited to a small geographical area serving a small set of devices on a Ethernet segment. However, by creating large wide area Layer 2 networks, the techniques described herein can support processing a tremendous number (e.g., hundreds of millions) of packets/frames per second by using wide area Layer 2 networks. Dense aggregation at the WAG 102 with a high performance forwarding plane (e.g., packet processing) allows service providers to, for example, inspect, and inject cloud-based bespoke data services (e.g. QoS, content filtering and parental control). The structures, functions, and features of the WAG 102 are described in more detail below with reference to FIG. 2.

Referring to the network 106, the WAG 102 and the radio nodes 104 are connected via the network 106. The network 106 can include Ethernet, cable network, any wired connection, any wireless connection, the Internet, a cellular network, a telephone network, a computer network, a packet switching network, a line switching network, a local area network (LAN), a wide area network (WAN), a personal area network (PAN), a metropolitan area network (MAN), a global area network, or any number of private networks currently referred to as an Intranet, or any other network or combination of networks that can accommodate data communication. Such networks may be implemented with any number of hardware and/or software components, transmission media and/or network protocols.

In some embodiments, the network 106 can be a Layer 2 domain. As a non-limiting example, the Layer 2 domain can be provided using Layer 2 switching that uses the media access control (MAC address) from a device to determine where to forward frames. The Layer 2 domain can implement the switching via hardware, such as using an application specific integrated circuit (ASIC) to build and maintain the filter tables. Additionally, for example, unlike other layers the Layer 2 domain does not need to modify the data packet. Thus the Layer 2 domain can be advantageous because it can provide high speed transmissions with low latency. As described above, the Layer 2 domain provides Layer 2 point-to-point tunnels between the radio nodes 104 and the WAG 102. For example, an IP point-to-point tunnel can be established so that Layer 2 packets can be wrapped in IP packets and transmitted freely between the radio nodes 104 and the WAG 102. Although FIG. 1 illustrates the network 106 as a single network, the network 106 can include multiple interconnected networks.

Referring to the radio node 104, the radio node 104 can include a processor configured to implement the functionality described herein using computer executable instructions stored in temporary and/or permanent non-transitory memory. The memory can be flash memory, a magnetic disk drive, an optical drive, a programmable read-only memory (PROM), a read-only memory (ROM), or any other memory or combination of memories. The processor can be a general purpose processor and/or can also be implemented using an ASIC, programmable logic array (PLA), field programmable gate array (FPGA), and/or any other integrated circuit.

In some embodiments, the radio node 104 can include a scheduler. The scheduler can make smart and/or informed decisions to provide Wi-Fi device 108 with QoS based on content aware QoS metadata supplied by the WAG 102. As explained further herein, in some embodiments, due to the system 100 structure the radio node 104 can be less complex than existing nodes, and can therefore be a lower-cost device. For example, access points such as the radio node 104 ideally may have certain IP classifying capability to provide Wi-Fi devices with QoS. These and other features often make access points complex and rigid because they are typically computation-constrained. The radio node 104 in the invention, on the other hand, can be less computation intensive while still providing high performance QoS. In some embodiments, the radio node 104 can be a home gateway or a wireless router.

Referring to Wi-Fi device 108, a Wi-Fi device 108 can include any type of device that supports Wi-Fi, including, without limitation, laptops, desktops, smartphones, tablets, gaming consoles, embedded household appliances (e.g., TVs, thermostats, video projectors, set-top boxes or set-top units, digital video recorders (DVR)), and/or other devices that support Wi-Fi.

Referring to the management entity 112, as described above with respect to the WAG 102, the management entity 112 can include a processor configured to implement the functionality described herein using computer executable instructions stored in temporary and/or permanent non-transitory memory. In some embodiments the management entity 112 is a cloud-based platform leveraging open compute application program interfaces (APIs) to the WAG 102.

In some embodiments, the management entity 112 can provide the WAG 102 with authentication, authorization, and accounting (AAA) management through certain protocols, including, without limitations, the remote authentication dial in user service (RADIUS) protocol and/or the Diameter protocol.

In some embodiments, the management entity 112 can provide policy and charging rules function (PCRF) to the WAG 102 through certain protocols, including, without limitations, the RADIUS protocol and/or the Diameter protocol. In some embodiments, the PCRF can provide, statically or dynamically, QoS rules to the WAG 102.

In some embodiments, the system 100 can include one or more of the following components: cloud services, cellular network, and access controller. For example, in some embodiments, the cloud services can include services that provide for sharing of digital media between multimedia devices. In some embodiments, the access controller can provide a highly scalable IP control plane to the radio nodes 104 that can be scaled linearly on demand.

The components of system 100 can include additional interfaces (not shown) that can allow the components to communicate with each other and/or other components, such as other devices on one or more networks, server devices on the same or different networks, or Wi-Fi devices either directly or via intermediate networks. The interfaces can be implemented in hardware to send and receive signals from a variety of mediums, such as optical, copper, and wireless, and in a number of different protocols, some of which may be non-transient.

FIG. 2 illustrates a block diagram of a Wi-Fi access gateway 102, or WAG 102, according to some embodiments of the disclosed subject matter. As shown in FIG. 2, the WAG 102 can include a processor 210, a memory 220, and a QoS module 230. The components illustrated in FIG. 2 can be further broken down into more than one component and/or combined together in any suitable arrangement. Further, one or more components can be rearranged, changed, added, and/or removed. For example, the QoS module 230 can be part of the memory 230 and/or can be separated from the memory 230.

The processor 210 can be configured to implement the functionality described herein using computer executable instructions stored in temporary and/or permanent non-transitory memory. The processor can be a general purpose processor and/or can also be implemented using an application specific integrated circuit (ASIC), programmable logic array (PLA), field programmable gate array (FPGA), and/or any other integrated circuit.

The processor 210 can execute an operating system (OS) that can be any suitable operating system, including a typical operating system such as Windows, Windows XP, Windows 7, Windows 8, Windows Mobile, Windows Phone, Windows RT, Mac OS X, Linux, VXWorks, Android, Blackberry OS, iOS, Symbian, or other OS.

In some embodiments, the processor 210 can reside in a data center and form a node in a cloud computing infrastructure. The processor 210 can also provide services on demand.

The QoS module 230 and/or other suitable components of the WAG 102 can be configured to implement the functionality described herein. For example, in some embodiments, the QoS module 230 can be configured to cause the processor 210 to provide metadata, such as content aware QoS metadata, for a Wi-Fi connection to nodes in a network. In some embodiments, the WAG 102 incorporates the QoS metadata into a packet header so that the nodes in the network can access the QoS metadata. In some embodiments, the QoS module 230 can be configured to cause the processor 210 to receive a data packet for an IP connection with a radio node across a network, where the radio node is configured to connect to one or more Wi-Fi devices located near the radio node. The QoS module 230 can be configured to cause the processor to classify underlying data content of the IP connection to determine QoS metadata for the IP connection based on the underlying data content (e.g., by performing deep-packet inspection). The QoS module 230 can be configured to incorporate the QoS metadata into a packet header of the data packet so that nodes in the network can access the QoS metadata for the IP connection. In some embodiments, the QoS module can be configured to cause other hardware component or components, software component or components, and/or suitable combination thereof to perform the functionality described herein. In some embodiments, the QoS module can be configured to directly perform the functionality described herein. In some embodiments, other hardware and/or software components of the WAG 102 can perform the functionality described herein.

The QoS module 230 can be implemented in software using the processor 210 and/or the memory 220. The memory 220 can be a non-transitory computer readable medium, flash memory, a magnetic disk drive, an optical drive, a PROM, a ROM, or any other memory or combination of memories.

FIG. 2 shows the WAG 102 having the QoS module 230 that performs the above-described operations in accordance with certain embodiments of the disclosed subject matter. The processor 210 and/or the WAG 102 may include additional modules, less modules, or any other suitable combination of modules that perform any suitable operation or combination of operations.

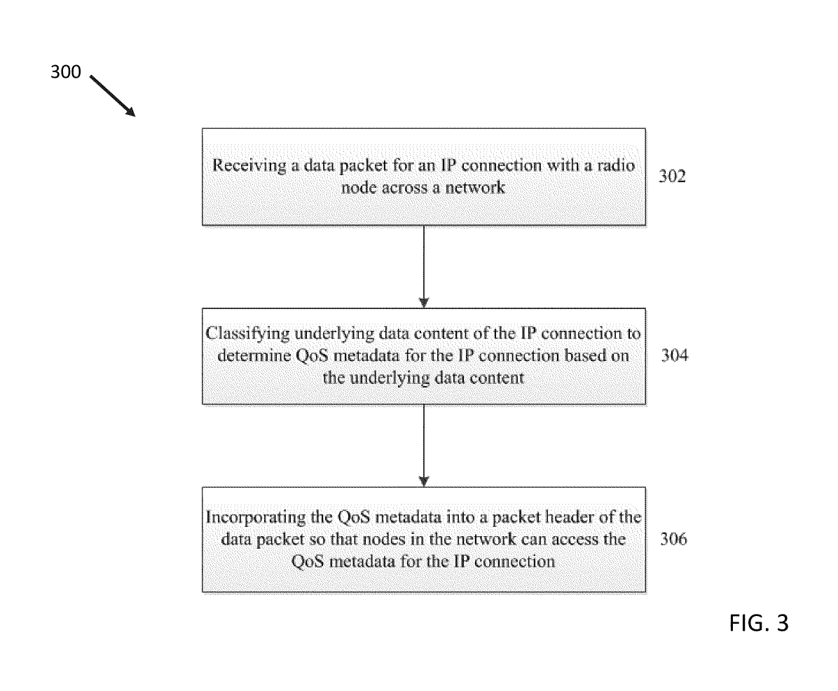

FIG. 3 illustrates a flow diagram illustrating a computerized process 300 implemented by the WAG 102 for providing content aware QoS metadata for a Wi-Fi connection to nodes in a network by incorporating the QoS metadata into a packet header so that the nodes in the network can access the QoS metadata. Although the process 300 is illustrated below in connection with the WAG 102, the process 300 can be implemented using other components of the WAG 102 such as the processor 210, the QoS module 230, and/or any other set of suitable components. The process 300 can be modified by, for example, having steps rearranged, changed, added, and/or removed.

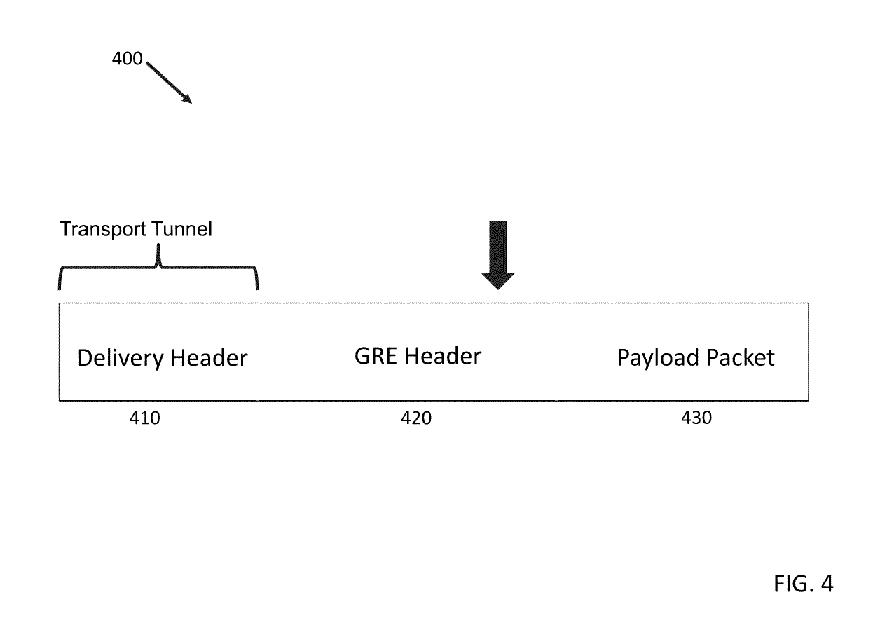

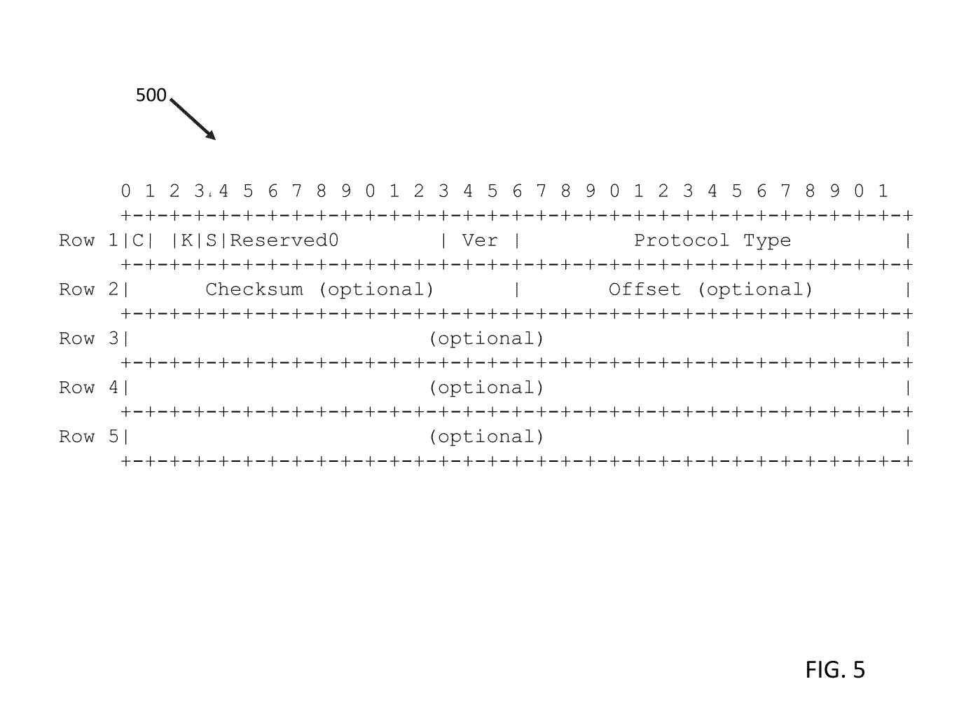

In step 302, the WAG 102 receives a data packet for an IP connection with the radio node 104 across a network, where the radio node 104 is configured to wirelessly connect to one or more Wi-Fi devices 108 located near the radio node 104. As a non-limiting example, the data packet can be sent from a source such as a website or a server and with a destination such as one of the Wi-Fi devices 108 and/or the radio nodes 104. The WAG 102 can receive the data packet via the Internet 110. The data packet can include IPv4, IPv6, or any other suitable version of IP addresses. The data packet can also have any suitable structures or protocols that are generally known in the art. An exemplar data packet is explained below in further details in connection with FIGS. 4 and 5.

FIG. 4 illustrates an exemplar data packet 400, according to some embodiments of the disclosed subject matter. The data packet 400 has a delivery header 410, a GRE header 420, and a payload packet 430. The components illustrated in FIG. 4 can be further broken down into more than one component and/or combined together in any suitable arrangement. Further, one or more components can be rearranged, changed, added, and/or removed. In some embodiments, the GRE header 420 can be other packet headers with suitable protocols.

The delivery header 410 can include a source IP address, a destination IP address, an IP version, and other suitable information. For example, the IP version can indicate the data packet is an IPv4 packet or an IPv6 packet. In other words, in some embodiments, the delivery header 410 can be an IPv6 header. In some embodiments, the delivery header 410 can be an IPv4 header.

FIG. 5 illustrates an exemplar GRE header 500, according to some embodiments of the disclosed subject matter. The GRE header 500 includes 160 bits, which are represented by five folded rows, with each row having 32 bits (the GRE header 500 is folded into five rows for illustration purpose only. In reality, the GRE header can be represented by a single row of data). In each row, the leftmost bit is referred to as Bit 0, and the rightmost bit is referred to as Bit 31. In some embodiments, more bits or fewer bits can be included in the GRE header 500. In some embodiments, the length of the GRE header 500 can be fixed or varied.

Referring to Row 1 of the GRE header 500, in some embodiments, Bit 0 can be set as the checksum bit, and if the checksum bit is set to 1, a checksum will be present in the GRE header 500. Bit 2 can be set as the key bit, and if the key bit is set to 1, an application-specific key value will be present in the GRE header 500. Bit 3 can be set as the sequence bit, and if the sequence bit is sent to 1, a sequence number will be present in the GRE header 500. Bits 1 and 4-12 can be set as reserved bits. Bits 13-15 can represent the version of the GRE header 500. Bits 16-31 can represent the prototype of the GRE header 500. Row two includes bits 0-15 that represent an optional checksum, and bits 16-31 that represent an optional offset. Rows three through five represent optional bits. In some embodiments, the GRE header 500 can have structures defined by one or more of RFC protocols.

Referring to the payload packet 430, the payload packet 430 represents the data that is being carried within the data packet 400. The payload packet 430 can be data transmitted under any suitable standards. As a non-limiting example, the payload packet 430 can be a 802.1q payload, which represents data transmitted under the IEEE 802.1q standard.

Referring to FIG. 3, after step 302 the process 300 then proceeds to step 304. In step 304, the WAG 102 classifies underlying data content of the IP connection to determine QoS metadata for the IP connection based on the underlying data content. In some embodiments, the WAG 102 can perform deep packet inspection of one or more packets from the data packet for the IP connection to classify the underlying content of the IP connection. In some embodiments, the data packet already includes certain QoS metadata from the upstream nodes such as the source server. The upstream QoS metadata can indicate how upstream nodes classify and/or prioritize the data packet based on the underlying content. For example, the upstream nodes may have already classified the data packet to indicate that the data packet belongs to certain application types such as the VoIP or for a Wi-Fi device with certain subscription statuses. In some embodiments, the WAG 102 can directly pass the upstream QoS metadata to the radio node 104. In some embodiments, as described in further details in connection with step 306, the WAG 102 can incorporate the upstream QoS metadata into the packet header of the data packet.

In some embodiments, the WAG 102 can determine the QoS metadata by classifying a flow QoS index of the data packet. In some embodiments, the flow QoS Index is a numeral that describes a QoS class that the underlying data content or a session of the underlying data content is mapped to. In some embodiments, different QoS indices can be assigned to different application types in order to indicate different QoS. For example, a voice application/traffic can be mapped to QoS Index 1; a video application/traffic can be mapped to QoS index 2; and a File Transfer Protocol (FTP) or e-mail application/traffic can be mapped to QoS Index 3. In some embodiments, a QoS index with higher number indicates a higher priority of QoS treatment. In some embodiments, a QoS index with lower number indicates a higher priority of QoS treatment.

In some embodiments, the WAG 102 can determine the QoS metadata by classifying the application associated with the underlying data content for the IP connection. For example, if the application associated with the underlying data content for the IP connection is a VoIP or video streaming that is sensitive to latency, the WAG 102 can determine the QoS metadata that indicates a high priority QoS treatment; if the application associated with the underlying data content for the IP connection is an iOS update that is not time sensitive and/or latency sensitive, the WAG 102 can determine the QoS metadata that indicates a low priority QoS treatment.

In some embodiments, the WAG 102 can determine the QoS metadata by classifying a status of a subscriber for the IP connection indicative of a level of service for the subscriber based on the subscriber's subscription level to the network. For example, the WAG 102 can determine which Wi-Fi device 108 or radio node 104 the data packet is sent to. If the Wi-Fi device 108 or the radio node 104 is associated with a subscriber with high subscription level, the WAG 102 can determine the QoS metadata that indicates a high priority QoS treatment; if the Wi-Fi device 108 or the radio node 104 is associated with a subscriber with low subscription level, the WAG 102 can determine the QoS metadata that indicates a low priority QoS treatment. As a non-limiting example, in some embodiments, the subscription level can be based on a subscriber's subscription fee for the network 106 or the Internet 110.

In some embodiments, the WAG 102 can determine the QoS metadata by classifying a flow priority indicator that indicates a priority for a flow of the underlying data content or a session of the underlying data content. In some embodiments, the flow is a subcomponent of the underlying data content. For example, a voice application can have several voice flows, and each flow may require different QoS treatment. By assigning a flow priority indicator to each flow, the QoS can have finer granularity.

In some embodiments, the WAG 102 can determine the QoS metadata by classifying a usage policy for the subscriber indicative of the subscriber's usage amount of the network 106 and/or the Internet 110. For example, in some embodiments, the usage policy may grant a heavy user a high priority QoS treatment and a light user a low priority QoS treatment. In some embodiments, the usage policy may grant a heavy user a low priority QoS treatment and a light user a high priority QoS treatment. The WAG 102 can determine the QoS based on other suitable characteristics of the data packet and underlying data content. The process 300 then proceeds step 306.

In step 306, the WAG 102 incorporates the QoS metadata, which is determined in step 304 and/or by upstream nodes, into a packet header of the data packet so that the radio nodes in the network can access the QoS metadata for the IP connection. In some embodiments, the WAG 102 can set a bit in the packet header to indicate that the packet header includes the QoS metadata and add the QoS metadata to the packet header in one or more optional fields of the header.

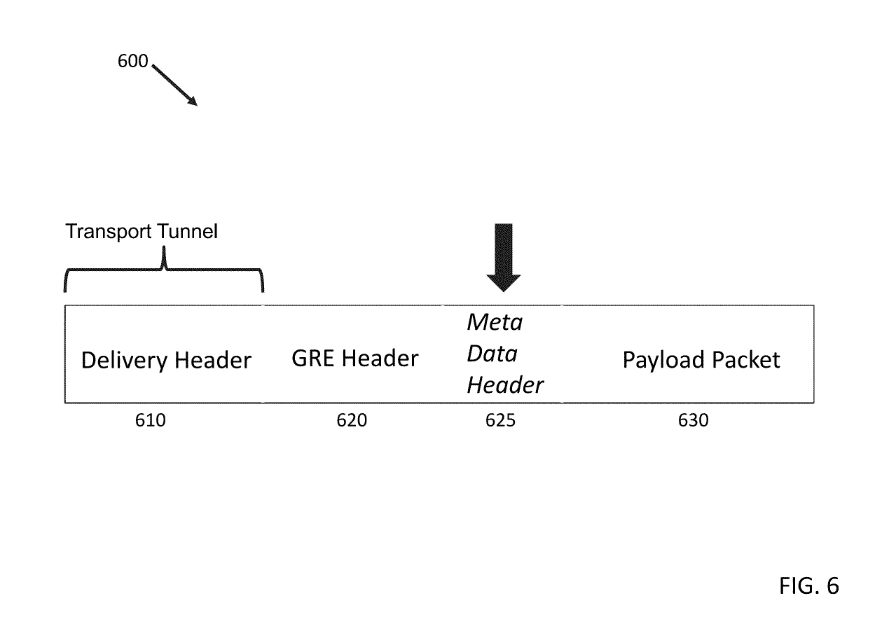

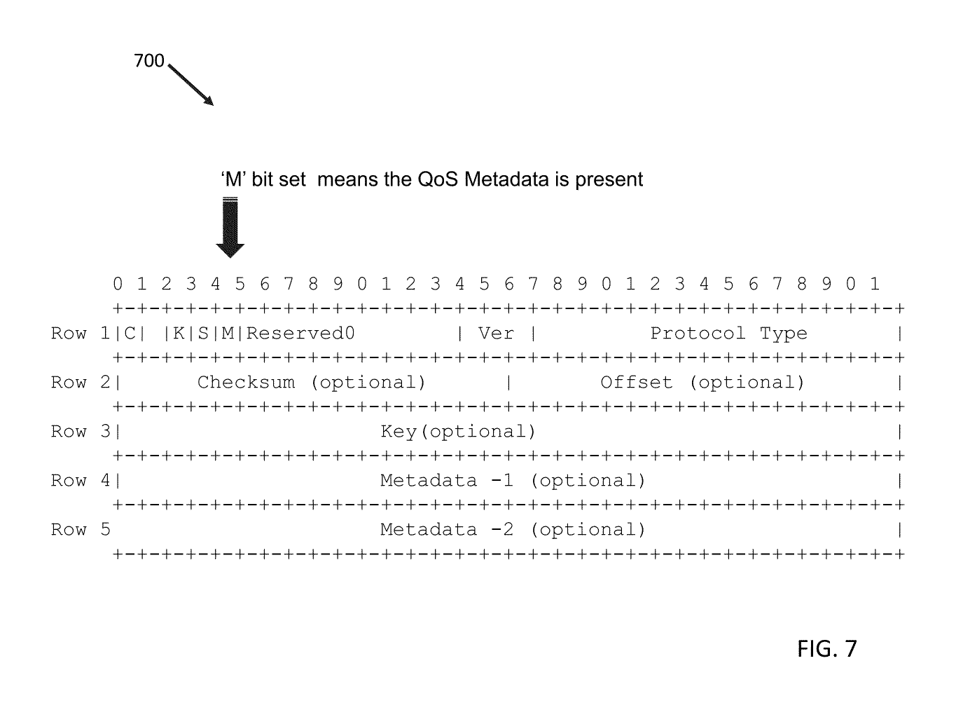

FIG. 6 illustrates an exemplar approach to incorporate the QoS metadata into the data packet 600, according to some embodiments of the disclosed subject matter. The data packet 600 has a delivery header 610, a GRE header 620, a metadata header 625, and a payload packet 630. The components illustrated in FIG. 6 can be further broken down into more than one component and/or combined together in any suitable arrangement. Further, one or more components can be rearranged, changed, added, and/or removed. In some embodiments, the GRE header 620 can be any other packet headers with suitable protocols. The structure of the delivery header 610 and the payload packet 630 can be respectively similar to that of the delivery header 410 and the payload packet 430 described in connection with FIG. 4. FIG. 6 further illustrates that the data packet 600 includes a metadata header 625, which occupies some of the optional fields of the GRE header 620. In some embodiments, the metadata header 625 represents metadata, such as the QoS metadata determined in step 306 of FIG. 3. The details of the incorporation of the QoS metadata into the GRE header 620 as the metadata header 625 is described further in connection with FIG. 7.

FIG. 7 illustrates an exemplar GRE header 700, according to some embodiments of the disclosed subject matter. The GRE header 700 includes 160 bits, which are represented by five rows of 32 bits. At each row, the leftmost bit is referred to as Bit 0, and the rightmost bit is referred to as Bit 31. In some embodiments, more bits or fewer bits can be included in the GRE header 500. In some embodiments, the length of the GRE header 700 can be fixed or varied.

Instead of being used as a reserved bit, one or more reserved bits can be used to indicate the presence of QoS metadata. For example, the fifth bit (which is Bit 4, Row 1) of the GRE header 620 can be used to indicate that the GRE header 700 includes the QoS metadata. In some embodiments, the bit (or bits) that indicates the presence of QoS metadata, such as the fifth bit of the GRE header 700, can be referred to as the metadata bit. When the metadata bit is set to 1, the QoS metadata will be present in the GRE header 700. For example, FIG. 7 illustrates that the QoS metadata can occupy 64 bits (Row 4 and Row 5) of the optional fields of the GRE header 700. In some embodiments, the QoS metadata can occupy more bits or fewer bits than 64 bits. FIG. 7 illustrates that the QoS metadata can occupy Row 4 and Row 5 of the optional fields of the GRE header 700. In some embodiments, the QoS metadata can occupy other suitable locations of the optional fields of the GRE header 700. In some embodiments, the QoS metadata can occupy consecutive optional fields of the GRE header 700. In some embodiments, the QoS metadata can occupy non-consecutive optional fields of the GRE header 700.

In some embodiments, when the radio node 104 receives the data packet 600, it can check whether the metadata bit is set. For example, the radio node 104 can check whether or not the fifth bit of the GRE header 620 is set to one. If the fifth bit is set to one, the radio node 104 can locate the corresponding QoS metadata and forward the data packet to one or more Wi-Fi devices 108 accordingly. In some embodiments, the metadata bit can be set to zero to indicate a presence of the metadata. As explained earlier, other bits of the GRE header 620 can be used to indicate the presence of the QoS metadata, and the GRE header 620 can be other suitable packet headers.

While the exemplary embodiments disclosed herein describe adding metadata to a packet by using the GRE header, one of skill in the art can appreciate that other header structures can be used in conjunction with, or instead of, the GRE header to provide the QoS metadata without departing from the spirit of the invention.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “module,” and “interface” is not software per se and includes at least some tangible, non-transitory hardware that is configured to execute computer readable instructions. In addition, the phrase “based on” does not imply exclusiveness—for example, if X is based on A, X can also be based on B, C, and/or D.

What is claimed is:

1. A computerized method for providing content aware quality of service (QoS) metadata for a Wi-Fi connection to nodes in a network by incorporating the QoS metadata into a packet header so that the nodes in the network can access the QoS metadata, the method comprising:
receiving, by a Wi-Fi access gateway, a data packet for an internet protocol (IP) connection with a radio node across the network, wherein the radio node is configured to connect to one or more Wi-Fi devices located near the radio node;
classifying, by the Wi-Fi access gateway, underlying data content of the IP connection to determine QoS metadata for the IP connection based on the underlying data content; and
incorporating, by the Wi-Fi access gateway, the QoS metadata into a packet header of the data packet so that nodes in the network can access the QoS metadata for the IP connection.

2. The method of claim 1, further comprising, for the data packet:
setting, by the Wi-Fi access gateway, a bit in the packet header to indicate that the packet header includes QoS metadata; and
adding, by the Wi-Fi access gateway, the QoS metadata to the packet header in one or more optional fields of the header.

3. The method of claim 2, wherein:
the packet header is a generic routing encapsulation (GRE) header; and
the bit is the fifth bit in the GRE header.

4. The method of claim 1, wherein classifying comprises performing deep packet inspection of one or more packets from the data packet for the IP connection to classify the underlying content of the IP connection.

5. The method of claim 1, wherein the content aware QoS metadata is selected from the group consisting of:
upstream QoS metadata indicative of how nodes upstream from the Wi-Fi access gateway should process the IP connection;
a flow QoS index indicative of a QoS class that the underlying data content is mapped to;
an application associated with the underlying data content for the IP connection;
a status of a subscriber for the IP connection indicative of a level of service for the subscriber based on the subscriber's subscription level to the wide area network;
a flow priority indicator that indicates a priority for a flow of the underlying data content; and
a usage policy for the subscriber indicative of the subscriber's usage amount of the wide area network.

6. A computing system configured to provide content aware quality of service (QoS) metadata for a Wi-Fi connection to nodes in a network by incorporating the QoS metadata into a packet header so that the nodes in the network can access the QoS metadata, comprising a Wi-Fi access gateway that includes a processor configured to run a module stored in memory that is configured to cause the processor to:
receive a data packet for an internet protocol (IP) connection with a radio node across the network, wherein the radio node is configured to connect to one or more Wi-Fi devices located near the radio node;
classify underlying data content of the IP connection to determine QoS metadata for the IP connection based on the underlying data content; and
incorporate the QoS metadata into a packet header of the data packet so that nodes in the network can access the QoS metadata for the IP connection.

7. The computing system of claim 6, wherein the module is further configured to cause the processor to:
set a bit in the packet header to indicate that the packet header includes QoS metadata; and
add the QoS metadata to the packet header in one or more optional fields of the header.

8. The computing system of claim 7, wherein:
the packet header is a generic routing encapsulation (GRE) header; and
the bit is the fifth bit in the GRE header.

9. The computing system of claim 6, wherein the module is further configured to cause the processor to perform deep packet inspection of one or more packets from the data packet for the IP connection to classify the underlying content of the IP connection.

10. The computing system of claim 6, wherein the content aware QoS metadata is selected from the group consisting of:
upstream QoS metadata indicative of how nodes upstream from the Wi-Fi access gateway should process the IP connection;
a flow QoS index indicative of a QoS class that the underlying data content is mapped to;
an application associated with the underlying data content for the IP connection;
a status of a subscriber for the IP connection indicative of a level of service for the subscriber based on the subscriber's subscription level to the wide area network;
a flow priority indicator that indicates a priority for a flow of the underlying data content; and
a usage policy for the subscriber indicative of the subscriber's usage amount of the wide area network.

11. A non-transitory computer readable medium comprising executable instructions operable to cause an apparatus to:
receive a data packet for an internet protocol (IP) connection with a radio node across the network, wherein the radio node is configured to connect to one or more Wi-Fi devices located near the radio node;
classify underlying data content of the IP connection to determine QoS metadata for the IP connection based on the underlying data content; and
incorporate the QoS metadata into a packet header of the data packet so that nodes in the network can access the QoS metadata for the IP connection.

12. The non-transitory computer readable medium of claim 11, wherein the executable instructions are further operable to cause the apparatus to:
set a bit in the packet header to indicate that the packet header includes QoS metadata; and
add the QoS metadata to the packet header in one or more optional fields of the header.

13. The non-transitory computer readable medium of claim 12, wherein:
the packet header is a generic routing encapsulation (GRE) header; and
the bit is the fifth bit in the GRE header.

14. The non-transitory computer readable medium of claim 11, wherein the executable instructions are further operable to cause the apparatus to perform deep packet inspection of one or more packets from the data packet for the IP connection to classify the underlying content of the IP connection.

15. The non-transitory computer readable medium of claim 11, wherein the content aware QoS metadata is selected from the group consisting of:
upstream QoS metadata indicative of how nodes upstream from the Wi-Fi access gateway should process the IP connection;
a flow QoS index indicative of a QoS class that the underlying data content is mapped to;
an application associated with the underlying data content for the IP connection;
a status of a subscriber for the IP connection indicative of a level of service for the subscriber based on the subscriber's subscription level to the wide area network;
a flow priority indicator that indicates a priority for a flow of the underlying data content; and
a usage policy for the subscriber indicative of the subscriber's usage amount of the wide area network.
